(19) United States
(12) Patent Application Publication
(10) Pub. No.: US 2025/0212230 A1
(43) Pub. Date: Jun. 26, 2025

(54) METHODS AND APPARATUSES FOR PHYSICAL SIDELINK FEEDBACK CHANNEL (PSFCH) TRANSMISSION

(71) Applicant: LENOVO (BEIJING) LIMITED, Beijing (CN)

(72) Inventors: Xin GUO, Beijing (CN); Haipeng LEI, Beijing (CN); Zhennian SUN, Beijing (CN); Xiaodong YU, Beijing (CN)

(21) Appl. No.: 18/848,333

(22) PCT Filed: Mar. 22, 2022
(86) PCT No.: PCT/CN2022/082315

§ 371 Date: Sep. 18, 2024

(51) Int. Cl. H04W 72/25

(52) U.S. Cl. CPC H04W 72/25

(57) ABSTRACT

Embodiments of the present disclosure relate to methods and apparatuses for physical sidelink feedback channel (PSFCH) transmission. According to an embodiment of the present disclosure, a user equipment (UE) can include: a processor configured to: obtain first configuration information indicating PSFCH resources in the time domain, wherein the first configuration information includes at least one set of parameters associated with at least one physical sidelink shared channel (PSSCH) transmission type, wherein each set of parameters includes at least one of: a time offset, a period, or a minimum gap; obtain second configuration information indicating PSFCH resources in the frequency domain, wherein the second configuration information includes at least one of: physical resource block (PRB) feedback list(s) available for PSFCH transmission(s); number(s) of PRBs for PSFCH transmission(s); resource pattern(s) for PSFCH transmission(s); or resource mapping type(s) for PSFCH transmission(s); and determine at least one PSFCH resource for an intended PSFCH transmission based on the first configuration information, the second configuration information, and a PSSCH transmission associated with the intended PSFCH transmission; a transmitter coupled to the processor and configured to transmit the intended PSFCH transmission on the determined at least one PSFCH resource; and a receiver coupled to the processor.

### TECHNICAL FIELD

Embodiments of the present application are generally related to wireless communication technologies, and more particularly, related to methods and apparatuses for PSFCH transmission.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system, e.g., 3GPP new radio (NR) vehicle to everything (V2X), has been introduced into 3GPP 5G wireless communication technology, in which a direct link between two UEs is called a sidelink.

PSFCH is one of the physical channels specified in 3GPP NR V2X. The key purpose of the PSFCH is to carry the hybrid automatic repeat request (HARQ) feedback from Rx UE(s) to a Tx UE. Currently, details regarding how to reduce resource collision of PSFCH transmissions need to be further discussed.

### SUMMARY OF THE APPLICATION

Embodiments of the present application at least provide a technical solution for PSFCH transmission.

According to some embodiments of the present application, a UE may include: a processor configured to: obtain first configuration information indicating PSFCH resources in the time domain, wherein the first configuration information includes at least one set of parameters associated with at least one physical sidelink shared channel (PSSCH) transmission type, wherein each set of parameters includes at least one of: a time offset, a period, or a minimum gap; obtain second configuration information indicating PSFCH resources in the frequency domain, wherein the second configuration information includes at least one of: physical resource block (PRB) feedback list(s) available for PSFCH transmission(s); number(s) of PRBs for PSFCH transmission(s); resource pattern(s) for PSFCH transmission(s); or resource mapping type(s) for PSFCH transmission(s); and determine at least one PSFCH resource for an intended PSFCH transmission based on the first configuration information, the second configuration information, and a PSSCH transmission associated with the intended PSFCH transmission; a transmitter coupled to the processor and configured to transmit the intended PSFCH transmission on the determined at least one PSFCH resource; and a receiver coupled to the processor.

In some embodiments of the present application, the at least one set of parameters is configured or pre-configured in at least one of the following granularities: per resource pool; or per PSSCH transmission type.

In some embodiments of the present application, a PSSCH transmission type indicates that a PSSCH transmission belongs to a slot level or a sub-slot level.

In some embodiments of the present application, the resource pattern(s) includes at least one of a contiguous pattern or an interleaved pattern, the contiguous pattern indicates that PRBs for a PSFCH transmission are labelled in a consecutive way within a range of resources for the PSFCH transmission, and the interleaved pattern indicates that PRBs for a PSFCH transmission have a same index in multiple PRB sets within a range of resources for the PSFCH transmission. The resource pattern may be valid only in the case that the number of PRBs for a PSFCH transmission is larger than 1. That is, only in the case that the number of PRBs for an intended PSFCH transmission is more than one, the resource pattern of multiple PRBs for one HARQ feedback transmission can be either contiguous or interleaved; otherwise (i.e., the number of PRBs for an intended PSFCH transmission is one), the resource pattern is invalid or does not exist.

In some embodiments of the present application, at least one of the number(s) of PRBs or the resource pattern(s) is configured or pre-configured in at least one of the following granularities: per resource pool, per PSFCH symbol type, per PSSCH transmission type, or per priority of an associated PSSCH transmission.

In some embodiments of the present application, the PSFCH symbol type includes a shared PSFCH symbol (SFS) or an independent PSFCH symbol (IFS).

In some embodiments of the present application, to determine the at least one PSFCH resource for the intended PSFCH transmission, the processor is configured to: determine a set of parameters from the at least one set of parameters based on a PSSCH transmission type of the PSSCH transmission; and determine a slot index of a slot for the PSFCH transmission based on a slot index of the PSSCH transmission and the set of parameters.

In some embodiments of the present application, the processor is further configured to: determine a PSFCH symbol type of a PSFCH symbol in the slot for the PSFCH transmission based on a time offset and a period associated with each PSSCH transmission type as indicated by the first configuration information.

In some embodiments of the present application, the PRB feedback list(s) includes a PRB feedback list for SFS for slot level PSSCH transmission, a PRB feedback list for SFS for sub-slot level PSSCH transmission, a PRB feedback list for IFS for slot level PSSCH transmission, and a PRB feedback list for IFS for sub-slot level PSSCH transmission.

In some embodiments of the present application, to determine the at least one PSFCH resource for the intended PSFCH transmission, the processor is configured to: determine a first PRB list for the intended PSFCH transmission from the PRB feedback list for SFS for slot level PSSCH transmission, the PRB feedback list for SFS for sub-slot level PSSCH transmission, the PRB feedback list for IFS for slot level PSSCH transmission, and the PRB feedback list for IFS for sub-slot level PSSCH transmission based on at least one of: whether a PSFCH symbol for the intended PSFCH transmission is an SFS or an IFS; or whether the PSSCH transmission is a slot level PSSCH transmission or a sub-slot level PSSCH transmission.

In some embodiments of the present application, to determine the at least one PSFCH resource for the intended PSFCH transmission, the processor is further configured to: determine a second PRB list from the first PRB list based on a slot index of the PSSCH transmission, sub-channel index(es) of the PSSCH transmission, and a resource mapping type included in the second configuration information, wherein the resource mapping type indicates whether the second PRB list is within PSFCH resources corresponding to all sub-channels of the PSSCH transmission or a part of sub-channels of the PSSCH transmission.

In some embodiments of the present application, the receiver is configured to: receive sidelink control information (SCI) associated with the PSSCH transmission, wherein the SCI indicates a second PRB list from the PRB list for the intended PSFCH transmission.

In some embodiments of the present application, in the case that the PSSCH transmission is a slot level PSSCH transmission, the processor is configured to determine the at least one PSFCH resource for the intended PSFCH transmission based on at least one of: the second PRB list; at least one code for the intended PSFCH transmission; an identity of the UE; or an identity of a transmitting UE associated with the PSSCH transmission.

In some embodiments of the present application, in the case that the PSSCH transmission is a sub-slot level PSSCH transmission, the processor is configured to determine the at least one PSFCH resource for the intended PSFCH transmission based on at least one of: the second PRB list; at least one code for the intended PSFCH transmission; an identity of the UE; an identity of a transmitting UE associated with the PSSCH transmission; a sub-slot level index of the PSSCH transmission; a number of PRBs for the intended PSFCH transmission; or a resource pattern for the intended PSFCH transmission.

According to some other embodiments, a BS may include: a transmitter configured to: transmit first configuration information indicating PSFCH resources in the time domain, wherein the first configuration information includes at least one set of parameters associated with at least one PSSCH transmission type, wherein each set of parameters includes at least one of: a time offset, a period, or a minimum gap; and transmit second configuration information indicating PSFCH resources in the frequency domain, wherein the second configuration information includes at least one of: PRB feedback list(s) available for PSFCH transmission(s); number(s) of PRBs for PSFCH transmission(s); resource pattern(s) for PSFCH transmission(s); or resource mapping type(s) for PSFCH transmission(s); a processor coupled to the transmitter; and a receiver coupled to the processor.

According to some other embodiments of the present application, a method performed by a UE may include: obtaining first configuration information indicating PSFCH resources in the time domain, wherein the first configuration information includes at least one set of parameters associated with at least one PSSCH transmission type, wherein each set of parameters includes at least one of: a time offset, a period, or a minimum gap; obtaining second configuration information indicating PSFCH resources in the frequency domain, wherein the second configuration information includes at least one of: PRB feedback list(s) available for PSFCH transmission(s); number(s) of PRBs for PSFCH transmission(s); resource pattern(s) for PSFCH transmission(s); or resource mapping type(s) for PSFCH transmission(s); determining at least one PSFCH resource for an intended PSFCH transmission based on the first configuration information, the second configuration information, and a PSSCH transmission associated with the intended PSFCH transmission; and transmitting the intended PSFCH transmission on the determined at least one PSFCH resource.

In some embodiments of the present application, the at least one set of parameters is configured or pre-configured in at least one of the following granularities: per resource pool; or per PSSCH transmission type.

In some embodiments of the present application, a PSSCH transmission type indicates that a PSSCH transmission belongs to a slot level or a sub-slot level.

In some embodiments of the present application, the resource pattern(s) includes at least one of a contiguous pattern or an interleaved pattern, the contiguous pattern indicates that PRBs for a PSFCH transmission are labelled in a consecutive way within a range of resources for the PSFCH transmission, and the interleaved pattern indicates that PRBs for a PSFCH transmission have a same index in multiple PRB sets within a range of resources for the PSFCH transmission.

In some embodiments of the present application, at least one of the number(s) of PRBs or the resource pattern(s) is configured or pre-configured in at least one of the following granularities: per resource pool, per PSFCH symbol type, per PSSCH transmission type, or per priority of an associated PSSCH transmission.

In some embodiments of the present application, the PSFCH symbol type includes an SFS or an IFS.

In some embodiments of the present application, determining the at least one PSFCH resource for the intended PSFCH transmission includes: determining a set of parameters from the at least one set of parameters based on a PSSCH transmission type of the PSSCH transmission; and determining a slot index of a slot for the PSFCH transmission based on a slot index of the PSSCH transmission and the set of parameters.

In some embodiments of the present application, the method may further include: determining a PSFCH symbol type of a PSFCH symbol in the slot for the PSFCH transmission based on a time offset and a period associated with each PSSCH transmission type as indicated by the first configuration information.

In some embodiments of the present application, the PRB feedback list(s) includes a PRB feedback list for SFS for slot level PSSCH transmission, a PRB feedback list for SFS for sub-slot level PSSCH transmission, a PRB feedback list for IFS for slot level PSSCH transmission, and a PRB feedback list for IFS for sub-slot level PSSCH transmission.

In some embodiments of the present application, determining the at least one PSFCH resource for the intended PSFCH transmission includes: determining a first PRB list for the intended PSFCH transmission from the PRB feedback list for SFS for slot level PSSCH transmission, the PRB feedback list for SFS for sub-slot level PSSCH transmission, the PRB feedback list for IFS for slot level PSSCH transmission, and the PRB feedback list for IFS for sub-slot level PSSCH transmission based on at least one of: whether a PSFCH symbol for the intended PSFCH transmission is an SFS or an IFS; or whether the PSSCH transmission is a slot level PSSCH transmission or a sub-slot level PSSCH transmission.

In some embodiments of the present application, determining the at least one PSFCH resource for the intended PSFCH transmission includes: determining a second PRB list from the first PRB list based on a slot index of the PSSCH transmission, sub-channel index(es) of the PSSCH transmission, and a resource mapping type included in the second configuration information, wherein the resource mapping type indicates whether the second PRB list is within PSFCH resources corresponding to all sub-channels of the PSSCH transmission or a part of sub-channels of the PSSCH transmission.

In some embodiments of the present application, the method may further include: receiving SCI associated with the PSSCH transmission, wherein the SCI indicates a second PRB list from the first PRB list for the intended PSFCH transmission.

In some embodiments of the present application, the method may further include: in the case that the PSSCH transmission is a slot level PSSCH transmission, determining the at least one PSFCH resource for the intended PSFCH transmission based on at least one of: the second PRB list; at least one code for the intended PSFCH transmission; an identity of the UE; or an identity of a transmitting UE associated with the PSSCH transmission.

In some embodiments of the present application, the method may further include: in the case that the PSSCH transmission is a sub-slot level PSSCH transmission, determining the at least one PSFCH resource for the intended PSFCH transmission based on at least one of: the second PRB list; at least one code for the intended PSFCH transmission; an identity of the UE; an identity of a transmitting UE associated with the PSSCH transmission; a sub-slot level index of the PSSCH transmission; a number of PRBs for the intended PSFCH transmission; or a resource pattern for the intended PSFCH transmission.

According to some other embodiments, a method performed by a base station (BS) may include: transmitting first configuration information indicating PSFCH resources in the time domain, wherein the first configuration information includes at least one set of parameters associated with at least one PSSCH transmission type, wherein each set of parameters includes at least one of: a time offset, a period, or a minimum gap; and transmitting second configuration information indicating PSFCH resources in the frequency domain, wherein the second configuration information includes at least one of: PRB feedback list(s) available for PSFCH transmission(s); number(s) of PRBs for PSFCH transmission(s); resource pattern(s) for PSFCH transmission(s); or resource mapping type(s) for PSFCH transmission(s).

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates two exemplary sidelink slot patterns according to some embodiments of the present application;

FIG. 3 illustrates a flowchart of an exemplary method for PSFCH transmission according to some embodiments of the present application;

FIG. 4 illustrates exemplary PSFCH resources in the time domain according to some embodiments of the present application;

FIG. 5 illustrates exemplary PSFCH resources in the time domain according to some other embodiments of the present application;

FIG. 6 illustrates an exemplary method for determining PSFCH resources in the time domain according to some embodiments of the present application;

FIG. 7 illustrates an exemplary method for determining PSFCH resources in the frequency domain according to some embodiments of the present application;

FIG. 8 illustrates another exemplary method for determining PSFCH resources in the frequency domain according to some embodiments of the present application; and

FIG. 9 illustrates a simplified block diagram of an exemplary apparatus for PSFCH transmission according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

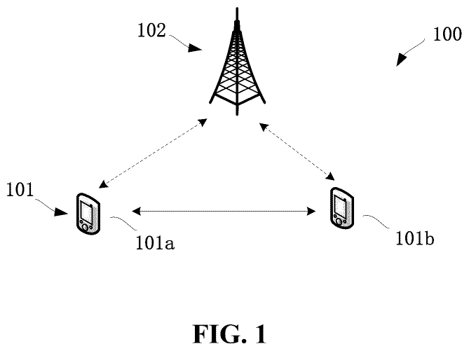

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present application, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 101 may include wearable devices, such as smart watches, fitness bands, optical head-mounted displays, or the like.

According to some embodiments of the present application, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols.

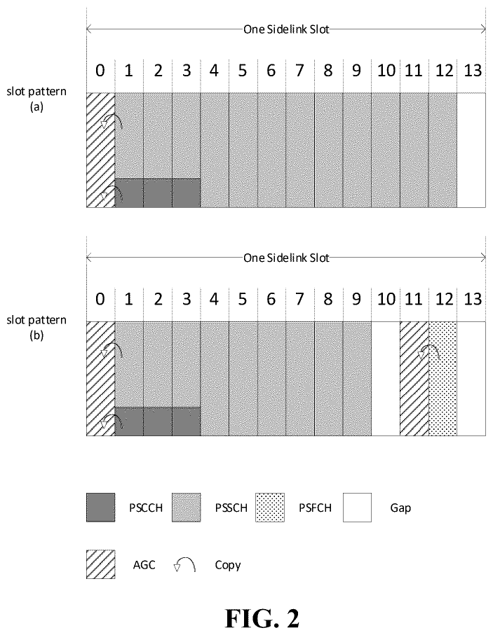

In general, supporting for an NR sidelink is firstly introduced in 3GPP Rel-16. A slot in which a sidelink communication may be performed can be referred to as a sidelink slot. Although a resource pool configuration has a slot-based granularity in the time domain, this does not preclude the case in which only a limited set of consecutive symbols within a sidelink slot is actually available for sidelink communication. The limited set of consecutive symbols can be configured by the first symbol of the set of consecutive symbols available for sidelink communication and the number of consecutive symbols available for sidelink communication. Without loss of generality, this application only illustrates examples where all 14 OFDM symbols within a sidelink slot are available for sidelink communication. As per NR sidelink slot specified in 3GPP Rel-16, the first symbol of the available OFDM symbols for sidelink communication of a sidelink slot is a copy of the second symbol of the available OFDM symbols for sidelink communication of the sidelink slot; and the first symbol of the available OFDM symbols for sidelink communication is used for an automatic gain control (AGC) purpose. The operation of AGC is performed by a UE when receiving a signal to determine an amplification degree, and thus, the UE can adjust the gain of a receiver amplifier to fit the power of the received signal. The specific examples of a sidelink slot are shown in FIG. 2, which are described as below.

FIG. 2 illustrates two exemplary sidelink slot patterns (or formats) according to some embodiments of the present application. As shown in FIG. 2, the two exemplary sidelink slot patterns may be referred to as slot pattern (a) and slot pattern (b). In the slot pattern (a) and slot pattern (b), one sidelink slot includes 14 OFDM symbols in total, i.e., OFDM symbol #0 to OFDM symbol #13. OFDM symbol #0 is used for AGC by repeating the first OFDM symbol (i.e., OFDM symbol #1) carrying physical sidelink shared channel (PSSCH) and/or physical sidelink control channel (PSCCH) transmissions. The last available OFDM symbol, i.e., OFDM symbol #13, is always used as a guard symbol (i.e., a gap). In addition, OFDM symbol #1, OFDM symbol #2, and OFDM symbol #3 are used to carry PSSCH and PSCCH transmissions. OFDM Symbol #4 to OFDM symbol #9 are used to carry PSSCH transmissions. An OFDM symbol carrying PSSCH and/or PSCCH transmissions may be named as “a PSSCH and/or PSCCH OFDM symbol,” “a PSSCH and/or PSCCH symbol,” or the like.

In the embodiments of FIG. 2, the difference between slot pattern (a) and slot pattern (b) lies in OFDM Symbol #10 to OFDM symbol #12. Specifically, in slot pattern (a), OFDM Symbol #10 to OFDM symbol #12 are used to carry PSSCH transmissions. However, in slot pattern (b), the HARQ feedback is enabled for the sidelink slot, and then a PSFCH transmission is transmitted in the second last available OFDM symbol (i.e., OFDM symbol #12 as shown in slot pattern (b) in FIG. 2) of the sidelink slot. An OFDM symbol carrying a PSFCH transmission may be named as “a PSFCH OFDM symbol,” “a PSFCH symbol,” or the like. One OFDM symbol right prior to the PSFCH symbol may be used for AGC and may include a copy of the PSFCH symbol. For example, OFDM symbol #11 as shown in slot pattern (b) in FIG. 2 is used for AGC by repeating the PSFCH symbol #12 as shown in slot pattern (b) in FIG. 2.

In some embodiments, a guard symbol (i.e., OFDM symbol #10 as shown in slot pattern (b) in FIG. 2) between the PSSCH and/or PSCCH symbol and the PSFCH symbol is needed to provide switching time between “a PSSCH and/or PSCCH reception” and “a PSFCH transmission.” This implies that, if PSFCH resources are configured for a sidelink slot, this will use a total of three OFDM symbols, including the AGC symbol and the extra guard symbol.

The sidelink slot patterns shown in FIG. 2 are provided for purpose of illustration. It is contemplated that other sidelink slot patterns may be applied.

Currently, in emerging latency critical applications (e.g., a factory automation scenario, automatic driving scenario, and so on), lower latency requirements are needed and thus cannot be satisfied by a slot-based sidelink transmission. For example, if SCSs are configured per resource pool and if a desired resource pool is configured with a shorter SCS (such as, 15 kHz or 30 kHz), it is required to reduce the transmission latency for the configured SCS. This implies that the latency on the resource pool cannot be reduced by applying a longer SCS. Therefore, sub-slot based sidelink slot pattern (or format) is introduced in supporting low latency and high spectrum efficiency sidelink transmission.

A sidelink sub-slot may refer to a fraction of a sidelink slot or a limited set of consecutive symbols within a sidelink slot. A sidelink sub-slot (SS) may also be named as “a sub-slot,” “a sidelink mini-slot,” “a mini-slot,” or the like.

In NR V2X, a Tx UE may transmit PSSCH transmission(s) to one or more Rx UE(s), and PSFCH may be used to carry HARQ feedback from Rx UE(s) to the TX UE. The HARQ feedback based retransmission has been defined for unicast transmission and groupcast transmission. For groupcast transmission, two feedback options, e.g., option 1 and option 2, are supported. Option 1 may refer to non-acknowledgement (NACK)-only feedback (i.e., the Rx UE only transmits feedback information of NACK to the Tx UE upon unsuccessful reception of a PSSCH transmission, and does not transmit feedback information of acknowledgement (ACK) upon successful reception of a PSSCH transmission). Option 2 may refer to ACK/NACK feedback (i.e., the Rx UE transmits feedback information of ACK to the Tx UE upon successful reception of a PSSCH transmission and transmits feedback information of NACK to the Tx UE upon unsuccessful reception of a PSSCH transmission). However, the use of HARQ feedback and the choice regarding whether to use option 1 or option 2 in groupcast transmission are up to a UE's implementation.

In the case of coexistence of slot level PSSCH sidelink transmission (also referred to as slot level PSSCH transmission) and sub-slot level PSSCH sidelink transmission (also referred to as sub-slot level PSSCH transmission) within the same resource pool (RP), there could possibly be a resource collision on PSFCH for the slot level PSSCH transmission and sub-slot level PSSCH transmission. In some embodiments of the present application, a PSSCH transmission type may indicate that a PSSCH transmission belongs to a slot level or a sub-slot level. A UE type may indicate that a UE belongs to a slot level or a sub-slot level. A slot level UE (also referred to as a slot UE) may refer to a UE which performs a slot level PSSCH transmission/reception or corresponding PSFCH transmission/reception. A sub-slot level UE (also referred to as a sub-slot UE) may refer to a UE which performs a sub-slot level PSSCH transmission/reception or corresponding PSFCH transmission/reception. That is, a slot level PSSCH transmission is associated with a slot level Tx UE and a slot level Rx UE, and a sub-slot level PSSCH transmission is associated with a sub-slot level Tx UE and a sub-slot level Rx UE. Accordingly, a PSSCH transmission type may be interchangeable with a UE type herein.

In the case of coexistence of slot level PSSCH transmission and sub-slot level PSSCH transmission within the same RP, at least the following issues are critical to be addressed:
Issue #1: how to address resource collision among PSFCH transmissions from multiple UEs, including sub-slot level UEs and/or slot level UEs.
Issue #2: how to address resource collision among multiple PSFCH transmissions and/or PSFCH receptions for one sub-slot level UE.

Embodiments of the present application provide improved solutions for PSFCH transmission, which provide several methods for solving at least one of the above technical issues, thereby facilitating the coexistence between the slot level sidelink transmissions and sub-slot level sidelink transmissions in the same resource pool. More details on embodiments of the present application will be illustrated in the following text in combination with the appended drawings.

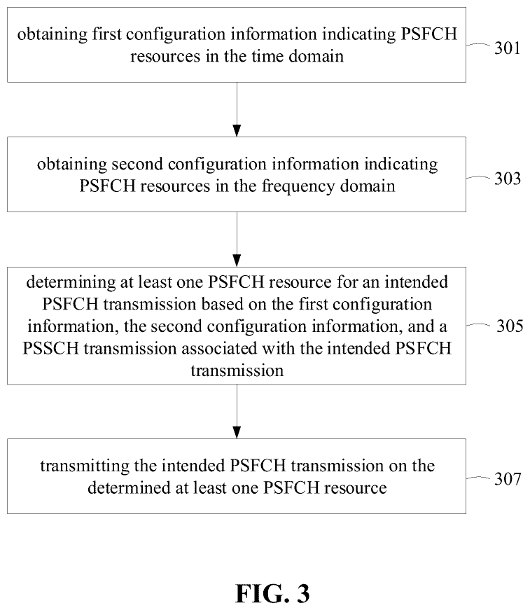

FIG. 3 illustrates a flowchart of an exemplary method for PSFCH transmission according to some embodiments of the present application. The method illustrated in FIG. 3 may be performed by a UE (e.g., UE 101a or UE 101b in FIG. 1) or other apparatus with the like functions.

As shown in FIG. 3, in step 301, a UE (e.g., an Rx UE which receives sidelink PSSCH transmission and/or PSCCH transmission) may obtain first configuration information indicating PSFCH resources in the time domain. In fact, the first configuration information is configured or pre-configured to all sidelink UEs, including both Rx UE which receives sidelink PSSCH transmission and/or PSCCH transmission and Tx UE which transmits sidelink PSSCH transmission and/or PSCCH transmission. The embodiment in FIG. 3 discusses the UE behavior in the case that the UE is an Rx UE.

In some embodiments of the present application, the UE may obtain the first configuration information based on configuration. Specifically, obtaining the first configuration information based on configuration (i.e., the first configuration information is configured to the UE) may refer to that: the first configuration information is transmitted by a BS (e.g., BS 102 as shown in FIG. 1) to the UE via a signaling, e.g., a system information block (SIB), a master information block (MIB), a radio resource control (RRC) signaling, a medium access control (MAC) layer control element (CE), or downlink control information (DCI), such that the UE may receive the first configuration information from the BS. In an embodiment of the present application, obtaining the first configuration information based on configuration may apply to the scenario where the UE is in coverage of a network.

In some other embodiments of the present application, the UE may obtain the first configuration information based on pre-configuration. Specifically, obtaining the first configuration information based on pre-configuration (i.e., the first configuration information is pre-configured to the UE) may refer to that: the first configuration information may be hard-wired into the UE or stored on a subscriber identity module (SIM) or universal subscriber identity module (USIM) card for the UE, such that the UE may obtain the first configuration information within the UE. In an embodiment of the present application, obtaining the first configuration information based on pre-configuration may apply to the scenario where the UE is out of coverage of the network.

The first configuration information may include at least one set of parameters associated with at least one PSSCH transmission type. A PSSCH transmission type may indicate that a PSSCH transmission belongs to a slot level or a sub-slot level. Accordingly, the first configuration information may include at least one of a set of parameters associated with slot level PSSCH transmission, a set of parameters associated with sub-slot level PSSCH transmission, or a set of parameters associated with both slot level PSSCH transmission and sub-slot level PSSCH transmission.

Each set of parameters of the at least one set of parameters may include at least one of: a time offset; a period, or a minimum gap.

The time offset may indicate a time offset (e.g., in number of time units) of the first slot with PSFCH relative to a reference point in one resource pool. In an embodiment, the time unit is one of: a slot, a sub-slot, a mini-slot, a symbol, etc. For example, a time offset may equal N (N is a non-negative integer) slot(s). In an embodiment, the reference point may be the first slot (labelled as slot #0) of the resource pool. However, the reference point may be any other slots in some other embodiments of the present application.

Resources for PSFCH can be configured or pre-configured periodically in the time domain within a resource pool. The period may indicate a period (e.g., in number of slots) of the PSFCHs. For example, the period of the PSFCHs may be 1 slot, 2 slots, or 4 slots, which means that there is a slot with PSFCH every 1 slot, 2 slots, or 4 slots.

The time offset and the period may be used for determining the slots with PSFCH symbols. After determining the slots with PSFCH symbols, the location of PSFCH symbol in each slot may be obtained by pre-defined slot pattern (e.g., symbol #12 as shown in slot pattern (b) in FIG. 2).

The minimum gap may be used to determine the slot where an intended PSFCH transmission (e.g., HARQ feedback) for an associated PSSCH transmission is located. The PSFCH symbol that can be used for HARQ feedback for an associated PSSCH transmission corresponds to the PSFCH in the first slot with PSFCH after the minimum gap after the associated PSSCH transmission. That is to say, the principle for determining a slot (hereinafter referred to as an intended PSFCH slot) for an intended HARQ feedback associated with a PSSCH transmission includes the following conditions 1 and 2. Condition 1 is that: the intended PSFCH slot is after the associated PSSCH slot (i.e., a slot for the associated PSSCH transmission) and the time difference between the intended PSFCH slot and the associated PSSCH slot should be greater than or equal to the minimum gap. Condition 2 is that: the intended PSFCH slot is the first slot with PSFCH satisfying condition 1. The minimum gap constrained by the condition 1 is set for providing sufficient processing delay for the UE between decoding the PSSCH and transmitting HARQ feedback. The first slot constrained by the condition 2 is set for the HARQ to be fed back as early as possible.

According to some embodiments of the present application, the at least one set of parameters is configured or pre-configured in at least one of the following granularities: per resource pool; or per PSSCH transmission type.

In some embodiments of the present application, the at least one set of parameters may be configured or pre-configured per resource pool. That is, for each resource pool, the first configuration information may include the at least one set of parameters associated with the resource pool.

In some other embodiments of the present application, the at least one set of parameters may be configured or pre-configured per PSSCH transmission type. That is, for each PSSCH transmission type, the first configuration information may include a set of parameters associated with the PSSCH transmission type. In other words, the first configuration information may include a corresponding set of parameters dedicated (specific) for each PSSCH transmission type. That is, each set of the at least one set of parameters is associated with a respective PSSCH transmission type of the at least one PSSCH transmission type.

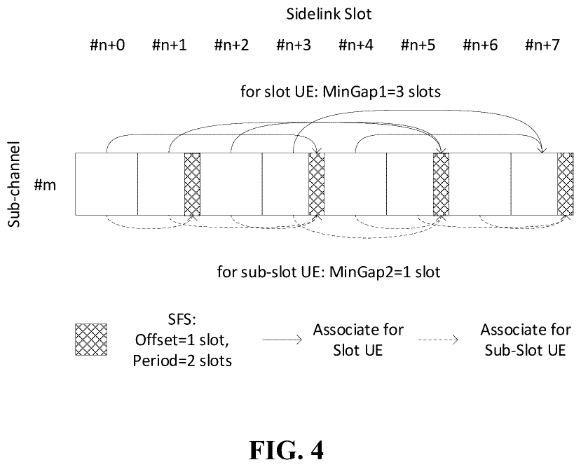

FIG. 4 illustrates exemplary PSFCH resources in the time domain according to some embodiments of the present application.

In the example of FIG. 4, the time offset and the period (e.g., the time offset=1 slot and the period=2 slots) configured or pre-configured for the resource pool are common (or identical) to the sub-slot level PSSCH transmission and the slot level PSSCH transmission. In addition, by considering different delay budgets required for the sub-slot level PSSCH transmission and the slot level PSSCH transmission, the minimum gap for the slot level PSSCH transmission is different from that for the sub-slot level PSSCH transmission. For example, the minimum gap for the slot level PSSCH transmission is 3 slots (i.e., MinGap1=3 slots) and the minimum gap for the sub-slot level PSSCH transmission is 1 slot (i.e., MinGap2=1 slot).

In the example of FIG. 4, “Offset=1 slot” may indicate that the time offset of the first slot with PSFCH relative to a reference point (e.g., slot #0) in the resource pool is 1 slot. That is, the first slot with PSFCH is slot #1 in the resource pool. “Period=2 slots” may indicate that there is a slot with PSFCH every 2 slots. Accordingly, the slots with PSFCH may include slot #1, slot #3, slot #5, and so on.

For simplicity, FIG. 4 only illustrates eight slots (e.g., slot #n+0 to slot #n+7, wherein n is non-negative even) and one sub-channel (e.g., sub-channel #m) in the resource pool as an example. Based on the configured or pre-configured time offset and period, it can be determined that the PSFCH symbols may be in slots #n+1, #n+3, #n+5, and #n+7. Since the time offset and the period are common to the slot level PSSCH transmission and the sub-slot level PSSCH transmission, the PSFCH symbols in the aforementioned four slots are shared by the slot level PSSCH transmission and the sub-slot level PSSCH transmission. Consequently, the PSFCH symbols in the four slots may be referred to as SFSs.

For slot level PSSCH transmissions, since MinGap1=3 slots,
for a slot level PSSCH transmission on slot #n+0, the UE may transmit the HARQ feedback on a PSFCH symbol in slot #n+3;
for a slot level PSSCH transmission on slot #n+1 or slot #n+2, the UE may transmit the HARQ feedback on a PSFCH symbol in slot #n+5;
for a slot level PSSCH transmission on slot #n+3 or slot #n+4, the UE may transmit the HARQ feedback on a PSFCH symbol in slot #n+7; and so on.

For sub-slot level PSSCH transmissions, since MinGap2=1 slot,
for a sub-slot level PSSCH transmission on slot #n+0, the UE may transmit the HARQ feedback on a PSFCH symbol in slot #n+1;
for a sub-slot level PSSCH transmission on slot #n+1 or slot #n+2, the UE may transmit the HARQ feedback on a PSFCH symbol in slot #n+3;
for a sub-slot level PSSCH transmission on slot #n+3 or slot #n+4, the UE may transmit the HARQ feedback on a PSFCH symbol in slot #n+5;
for a sub-slot level PSSCH transmission on slot #n+5 or slot #n+6, the UE may transmit the HARQ feedback on a PSFCH symbol in slot #n+7; and so on.

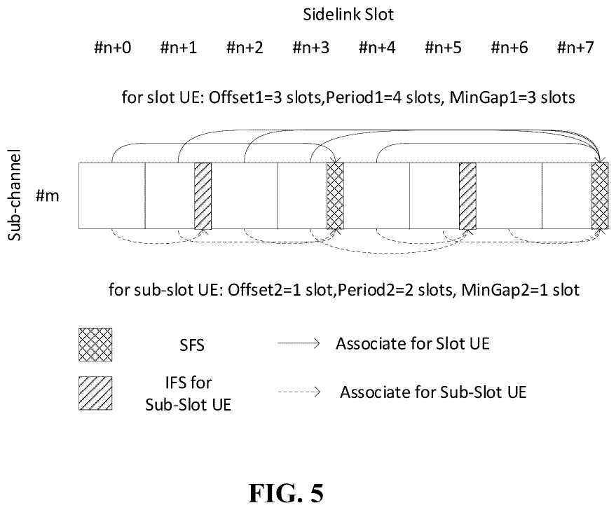

FIG. 5 illustrates exemplary PSFCH resources in the time domain according to some other embodiments of the present application. For simplicity, FIG. 5 also illustrates eight slots (e.g., slot #n+0 to slot #n+7, wherein n is a non-negative integer which is a multiple of 4) and one sub-channel (e.g., sub-channel #m) in the resource pool as an example.

In the example of FIG. 5, two sets of parameters are configured or pre-configured, wherein one set of parameters (i.e., time offset (offset1)=3 slots, period (period1)=4 slots, and minimum gap (MinGap1)=3 slots) is associated with slot level PSSCH transmission and the other set of parameters (i.e., time offset (time offset2)=1 slot, period (period2)=2 slots, and minimum gap (MinGap2)=1 slot) is associated with sub-slot level PSSCH transmission.

Based on the above principle for determining the PSFCH symbols, it can be determined that: for slot level PSSCH transmission, the PSFCH symbols may be in slots #n+3 and #n+7. Moreover, since MinGap1=3 slots,
for a slot level PSSCH transmission on slot #n+0, the UE may transmit the HARQ feedback on a PSFCH symbol in slot #n+3;
for a slot level PSSCH transmission on slot #n+1, slot #n+2, slot #n+3 or slot #n+4, the UE may transmit the HARQ feedback on a PSFCH symbol in slot #n+7; and so on.

In addition, based on the above principle for determining the PSFCH symbols, it can also be determined that: for sub-slot level PSSCH transmission, the PSFCH symbols may be in slots #n+1, #n+3, #n+5, and #n+7. Moreover, since MinGap2=1 slot,
for a sub-slot level PSSCH transmission on slot #n+0, the UE may transmit the HARQ feedback on a PSFCH symbol in slot #n+1;
for a slot level PSSCH transmission on slot #n+1 or slot #n+2, the UE may transmit the HARQ feedback on a PSFCH symbol in slot #n+3;
for a slot level PSSCH transmission on slot #n+3 or slot #n+4, the UE may transmit the HARQ feedback on a PSFCH symbol in slot #n+5;
for a slot level PSSCH transmission on slot #n+5 or slot #n+6, the UE may transmit the HARQ feedback on a PSFCH symbol in slot #n+7; and so on.

Referring to FIG. 5, the PSFCH symbols in slots #n+3 and #n+7 are shared by slot level PSSCH transmission and sub-slot level PSSCH transmission, and these PSFCH symbols may be referred to as SFSs.

In contrast, the PSFCH symbols in slots #n+1 and #n+5 are specific to sub-slot level PSSCH transmission, and these PSFCH symbols may be referred to as IFSs. The IFSs shown in FIG. 5 are IFSs specific for sub-slot level PSSCH transmission. It is contemplated that there may be IFSs specific for slot level PSSCH transmission in other cases.

In some embodiments of the present application, the UE may determine or identity a PSFCH symbol type of a PSFCH symbol (i.e., whether the PSFCH symbol is an SFS or an IFS) in a slot based on a time offset and a period associated with each PSSCH transmission type as indicated by the first configuration information.

For example, SFS can be identified if the following condition (1) is satisfied, and IFS can be identified if the following condition (2) is satisfied:

$$∃ i , j ∈ {ℤ}_{0}^{+} Offset 1 + i * Period 1 = Offset 2 + j * Period 2 \qquad ( 1 )$$

$$∄ i , j ∈ {ℤ}_{0}^{+} Offset 1 + i * Period 1 = Offset 2 + j * Period 2 \qquad ( 2 )$$

Wherein [symbol] ₀⁺ is a set of non-negative integers, Offset1 is a time offset for slot level PSSCH transmission, Period1 is a period for slot level PSSCH transmission, Offset2 is a time offset for sub-slot level PSSCH transmission, and Period2 is a period for sub-slot level PSSCH transmission. In the case that there are i and j (i, j∈ [symbol] ₀⁺) which can satisfy the equation in condition (1), the UE may determine that a PSFCH symbol in slot #(Offset1+i*Period1) and slot #(Offset2+j*Period2) is an SFS. In the case that there is no i and j (i, j∈ [symbol] ₀⁺) which can satisfy the equation in condition (2), the UE may determine that the PSFCH symbol in slot #(Offset1+i*Period1) is an IFS specific for slot level PSSCH transmission and slot #(Offset2+j*Period2) is an IFS specific for sub-slot level PSSCH transmission.

Referring to FIG. 5 as an example, for a slot level PSSCH transmission, Offset1=3 slots and Period1=4 slots; for a sub-slot level PSSCH transmission, Offset2=1 slot and Period2=2 slots. The UE may determine a PSFCH symbol in slot #3 is an SFS because the above equation in condition (1) is satisfied when i=0 and j=1 (i.e., 3+0*4=1+1*2=3). The UE may determine that a PSFCH symbol in slot #1 is an IFS specific for sub-slot level PSSCH transmission because there is no such value of i and j (i, j∈ [symbol] ₀⁺) which can satisfy the above equation in condition (2) when j=0 (i.e., 1+j*2=1).

The conditions (1) and (2) are examples for identifying IFS and SFS. In some other embodiments of the present application, a UE may determine whether a PSFCH symbol in a slot is an SFS or IFS by other methods when obtaining a time offset and a period associated with each PSSCH transmission type as indicated by the first configuration information.

Referring back to FIG. 3, in step 303, the UE (e.g., an Rx UE which receives sidelink PSSCH transmission and/or PSCCH transmission) may obtain second configuration information indicating PSFCH resources in the frequency domain. In fact, the second configuration information is configured or pre-configured to all sidelink UEs, including both Rx UE which receives sidelink PSSCH transmission and/or PSCCH transmission and Tx UE which transmits sidelink PSSCH transmission and/or PSCCH transmission.

In some embodiments of the present application, step 303 may occur before, after, or simultaneously with step 301. In some embodiments of the present application, the first configuration information and the second configuration information may be included in a single configuration information. That is, the configuration information may indicate both PSFCH resources in the time domain and PSFCH resources in the frequency domain.

In some embodiments of the present application, the UE may obtain the second configuration information based on configuration. Specifically, obtaining the second configuration information based on configuration (i.e., the second configuration information is configured to the UE) may refer to that: the second configuration information is transmitted by a BS (e.g., BS 102 as shown in FIG. 1) to the UE via a signaling, e.g., a SIB, a MIB, a RRC signaling, a MAC CE, or DCI, such that the UE may receive the second configuration information from the BS. In an embodiment of the present application, obtaining the second configuration information based on configuration may apply to the scenario where the UE is in coverage of a network.

In some other embodiments of the present application, the UE may obtain the second configuration information based on pre-configuration. Specifically, obtaining the second configuration information based on pre-configuration (i.e., the second configuration information is pre-configured to the UE) may refer to that: the second configuration information may be hard-wired into the UE or stored on a SIM or USIM card for the UE, such that the UE may obtain the second configuration information within the UE. In an embodiment of the present application, obtaining the second configuration information based on pre-configuration may apply to the scenario where the UE is out of coverage of the network.

The second configuration information may include at least one of: PRB feedback list(s) available for PSFCH transmission(s); number(s) of PRBs for PSFCH transmission(s); resource pattern(s) for PSFCH transmission(s); or resource mapping type(s) for PSFCH transmission(s).

The PRB feedback list(s) available for PSFCH transmission(s) may be associated with at least one of: a PSFCH symbol type or a PSSCH transmission type. In some embodiments, each PRB feedback list may include a set of PRBs available for HARQ feedback in each sub-channel. For example, the PRB feedback list may be indicated by a bitmap. Assuming that each sub-channel includes 20 PRBs, the bitmap may include 20 bits, and each bit is associated with a corresponding PRB and indicates whether the corresponding PRB is available for HARQ feedback or not.

According to some embodiments of the present application, as shown in Table 1, the PRB feedback list(s) included in the second configuration information may include a PRB feedback list for SFS for slot level PSSCH transmission (e.g., PRB-FB-List #A1), a PRB feedback list for SFS for sub-slot level PSSCH transmission (e.g., PRB-FB-List #A2), a PRB feedback list for IFS for slot level PSSCH transmission (e.g., PRB-FB-List #A3), and a PRB feedback list for IFS for sub-slot level PSSCH transmission (e.g., PRB-FB-List #A4).

TABLE 1

| | Slot level PSSCH | Sub-slot level PSSCH |
|---|---|---|
| | transmission | transmission |
| SFS | PRB-FB-List #A1 | PRB-FB-List #A2 |
| IFS | PRB-FB-List #A3 | PRB-FB-List #A4 |

The embodiments in Table 1 may be for illustrative purposes only. In some other embodiments, the PRB feedback list(s) included in the second configuration information may include a PRB feedback list for SFS, a PRB feedback list for IFS for slot level PSSCH transmission, and a PRB feedback list for IFS for sub-slot level PSSCH transmission.

The number(s) of PRBs for PSFCH transmission(s) may be configured or pre-configured in at least one of the following granularities: per resource pool, per PSSCH transmission type; per PSFCH symbol type, or per priority of an associated PSSCH transmission. A number of PRBs may be the number of PRBs used for each PSFCH transmission.

In some embodiments, the number(s) of PRBs may be configured or pre-configured per resource pool. That is, for each resource pool, the second configuration information may include the number(s) of PRBs for PSFCH transmissions associated with the resource pool.

In some other embodiments, the number(s) of PRBs may be configured or pre-configured per PSSCH transmission type. That is, for each PSSCH transmission type, the second configuration information may include a number of PRBs associated with the PSSCH transmission type. For example, the second configuration information may indicate 1 PRB associated with slot level PSSCH transmission and indicate 1, 2 or 4 PRB(s) associated with sub-slot level PSSCH transmission (or sub-slot UE) because more resources in the frequency domain may be needed for sub-slot level PSSCH transmission. In an embodiment, the second configuration information may not include the number of PRBs for one or more PSSCH transmission types, and the UE may determine that the number of PRBs for the one or more PSSCH transmission types is a default value (e.g., 1).

In some other embodiments, the number(s) of PRBs may be configured or pre-configured per PSFCH symbol type (e.g., whether a PSFCH symbol is an SFS or IFS). That is, for each PSFCH symbol type, the second configuration information may include a number of PRBs associated with the PSFCH symbol type. For example, the second configuration information may indicate 1 PRB associated with IFS and indicate 2 or 4 PRBs associated with SFS so as to increase reliability of PSFCH transmission on SFS.

In some other embodiments, the number(s) of PRBs may be configured or pre-configured per priority of an associated PSSCH transmission. For example, the second configuration information may indicate 2 or 4 PRBs for an associated PSSCH transmission with a priority higher than or equal to a configured or pre-configured priority threshold and may indicate 1 PRB for an associated PSSCH transmission with a priority lower than the configured or pre-configured priority threshold.

The resource pattern(s) for PSFCH transmission(s) may include at least one of a contiguous pattern or an interleaved pattern. The contiguous pattern indicates that PRBs for a PSFCH transmission are labelled in a consecutive way within a range of resources for the PSFCH transmission, and the interleaved pattern indicates that PRBs for a PSFCH transmission have a same index in multiple PRB sets within a range of resources for the PSFCH transmission. The resource pattern(s) may also be configured or pre-configured in at least one of the following granularities: per resource pool, per PSSCH transmission type, per PSFCH symbol type, or per priority of an associated PSSCH transmission.

In some embodiments, the resource pattern(s) may be configured or pre-configured per resource pool. That is, for each resource pool, the second configuration information may include the resource pattern(s) associated with the resource pool.

In some other embodiments, the resource pattern(s) may be configured or pre-configured per PSSCH transmission type. That is, for each PSSCH transmission type, the second configuration information may indicate a resource pattern associated with the PSSCH transmission type.

In some other embodiments, the resource pattern(s) may be configured or pre-configured per PSFCH symbol type (e.g., whether a PSFCH symbol is an SFS or IFS). That is, for each PSFCH symbol type, the second configuration information may include a resource pattern associated with the PSFCH symbol type.

In some other embodiments, the resource pattern(s) may be configured or pre-configured per priority of an associated PSSCH transmission. For example, the second configuration information may indicate a resource pattern for an associated PSSCH transmission with a priority higher than or equal to a configured or pre-configured priority threshold and may indicate another resource pattern for an associated PSSCH transmission with a priority lower than the configured or pre-configured priority threshold.

The resource mapping type(s) may also be configured or pre-configured in at least one of the following granularities: per resource pool, per PSSCH transmission type; per PSFCH symbol type, or per priority of an associated PSSCH transmission. A resource mapping type may indicate whether PRBs for a PSFCH transmission are within PSFCH resources corresponding to all sub-channels of the associated PSSCH transmission or a part of sub-channels of the associated PSSCH transmission.

In some embodiments, the resource mapping type(s) may be configured or pre-configured per resource pool. That is, for each resource pool, the second configuration information may include resource mapping type(s) associated with the resource pool.

In some other embodiments, the resource mapping type(s) may be configured or pre-configured per PSSCH transmission type. That is, for each PSSCH transmission type, the second configuration information may indicate a resource mapping type associated with the PSSCH transmission type.

In some other embodiments, the resource mapping type(s) for PSFCH may be configured or pre-configured per PSFCH symbol type (e.g., whether a PSFCH symbol is an SFS or IFS). That is, for each PSFCH symbol type, the second configuration information may include a resource mapping type associated with the PSFCH symbol type.

In some other embodiments, the resource mapping type(s) may be configured or pre-configured per priority of an associated PSSCH transmission. For example, the second configuration information may indicate a resource mapping type for an associated PSSCH transmission with a priority higher than or equal to a configured or pre-configured priority threshold and may indicate another resource mapping type for an associated PSSCH transmission with a priority lower than the configured or pre-configured priority threshold.

In some embodiments of the present application, at least two of a number of PRBs, a resource pattern, or a resource mapping type may be combined as a combined option, and the second configuration information may include one or more combined options. The one or more combined options may also be configured or pre-configured in at least one of the following granularities: per resource pool, per PSSCH transmission type; per PSFCH symbol type, or per priority of an associated PSSCH transmission.

After obtaining the first configuration information and the second configuration information, the UE may receive and decode a PSCCH transmission and a PSSCH transmission associated with the PSCCH transmission (e.g., including at least one of a SCI and a transport block (TB) associated with the SCI) transmitted from a Tx UE. Then, in the case that the HARQ feedback is enabled, the UE may determine a HARQ feedback (e.g., ACK or NACK) according to the decoding results of the PSSCH transmission.

Then, in step 305, the UE (e.g., an Rx UE which receives sidelink PSCCH transmission and a PSSCH transmission associated with the PSCCH transmission) may determine at least one PSFCH resource for an intended PSFCH transmission based on the first configuration information, the second configuration information, and the PSSCH transmission associated with the intended PSFCH transmission. The intended PSFCH transmission may include the HARQ feedback (e.g., ACK or NACK) determined above for the PSSCH transmission.

Specifically, determining the at least one PSFCH resource for the intended PSFCH transmission may include the following steps.

First, the Rx UE may determine a set of parameters from the at least one set of parameters included in the first configuration information based on a PSSCH transmission type of the PSSCH transmission. Specifically, as stated above, the at least one set of parameters may include one set of parameters common to all the PSSCH transmission types or each set of parameters may be associated with a PSSCH transmission type. Then, based on the PSSCH transmission type of the PSSCH transmission, the Rx UE may determine the set of parameters.

Then, the Rx UE may determine a slot index of a slot for the PSFCH transmission based on a slot index of the PSSCH transmission and the determined set of parameters. The specific examples for determine a slot index for a slot for the PSFCH transmission may refer to the examples described with respect to FIG. 4 and FIG. 5 above.

After determining the slot index of the slot for the PSFCH transmission, the Rx UE may determine a PSFCH symbol type of a PSFCH symbol in the determined slot for the PSFCH transmission based on a time offset and a period associated with each PSSCH transmission type as indicated by the first configuration information. For example, the Rx UE may determine the PSFCH symbol type based on condition (1) and condition (2) as stated above.

The PSFCH symbol type may be used for determining a first PRB list from all PRB feedback lists included in the second configuration information. For example, as stated above, the PRB feedback lists in the second configuration information may include a PRB feedback list for SFS for slot level PSSCH transmission, a PRB feedback list for SFS for sub-slot level PSSCH transmission, a PRB feedback list for IFS for slot level PSSCH transmission, and a PRB list for IFS for sub-slot level PSSCH transmission. Then, the Rx UE may determine the first PRB list from the above four lists based on at least one of: whether the PSFCH symbol for the intended PSFCH transmission is an SFS or an IFS; or whether the PSSCH transmission is a slot level PSSCH transmission or a sub-slot level PSSCH transmission.

After determining the first PRB list, in some embodiments, the Rx UE may determine a second PRB list for the intended PSFCH transmission from the first PRB list. The second PRB list may include at least a part of the first PRB list. For example, the second PRB list may include at least one set of PRBs, which includes part or all of PRBs in the first PRB list.

In some embodiments, the Rx UE may determine the second PRB list based on the slot index of the associated PSSCH transmission, sub-channel index(es) of the associated PSSCH transmission, and a resource mapping type included in the second configuration information. In such embodiments, in the case that a unique resource mapping type can be determine based on the second configuration information (e.g., the second configuration information only includes one resource mapping type or the resource mapping type is configured or pre-configured per PSSCH transmission type or UE type or PFSCH symbol type), the Rx UE may use the unique resource mapping type to determine the second PRB list. In some other embodiments, the second configuration information may include multiple resource mapping types. In such embodiments, the Rx UE may receive the SCI associated with the PSSCH transmission from the Tx UE, and the SCI (e.g., 2nd-stage SCI) may indicate the resource mapping type for determining the second PRB list from the multiple resource mapping types.

In some other embodiments, the Rx UE may receive the SCI associated with the PSSCH transmission from the Tx UE, and the SCI (e.g., 2nd-stage SCI) may indicate the second PRB list based on sensing results of the Tx UE.

After determining the second PRB list, the Rx UE may determine the at least one PSFCH resource for the intended PSFCH transmission.

In some embodiments, in the case that the PSSCH transmission is a slot level PSSCH transmission, the Rx UE may determine the at least one PSFCH resource for the intended PSFCH transmission based on at least one of: the second PRB list; at least one code for the intended PSFCH transmission; an identity of the Rx UE; or an identity of the Tx UE associated with the PSSCH transmission.

In some other embodiments, in the case that the PSSCH transmission is a sub-slot level PSSCH transmission, the Rx UE may determine the at least one PSFCH resource for the intended PSFCH transmission based on at least one of: the second PRB list; at least one code for the intended PSFCH transmission; an identity of the Rx UE; an identity of the Tx UE associated with the PSSCH transmission; a sub-slot index of the PSSCH transmission; a number of PRBs for the intended PSFCH transmission; or a resource pattern for the intended PSFCH transmission.

In an embodiment, the number of PRBs for the intended PSFCH transmission and/or the resource pattern for the intended PSFCH transmission may be determined based on the second configuration information in the case that the number of PRBs for the intended PSFCH transmission and/or the resource pattern for the intended PSFCH transmission can be uniquely determined based on the second configuration information; otherwise, the Rx UE may receive the SCI associated with the PSSCH transmission from the Tx UE, and the SCI may indicate at least one of the number of PRBs for the intended PSFCH transmission or the resource pattern for the intended PSFCH transmission.

In another embodiment, the SCI transmitted from the Tx UE may indicate an option for the intended PSFCH transmission to the Rx UE, and the option may indicate at least one of: the resource mapping type, the number of PRBs, or the resource pattern used for the intended PSFCH transmission.

In the above embodiments, the at least one code for the intended PSFCH transmission may be generated based on a sequence, e.g., Zadoff-Chu sequence, pseudo random sequence, Gold sequence, etc. For example, in the case that a Zadoff-Chu sequence is used, a code may refer to a pair of cyclic shifts for each PRB and may be indicated by a code index.

Then, in step 307, the Rx UE may transmit the intended PSFCH transmission (e.g., HARQ feedback) for the PSSCH transmission on the determined at least one PSFCH resource to the Tx UE.

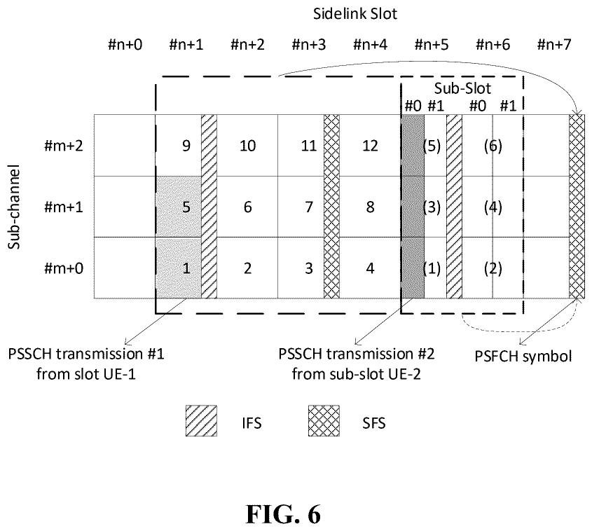

FIG. 6 illustrates an exemplary method for determining PSFCH resources in the time domain according to some embodiments of the present application. For simplicity, FIG. 6 illustrates eight slots (e.g., slot #n+0 to slot #n+7, wherein n is a non-negative integer which is a multiple of 4) and three sub-channel (e.g., sub-channel #m+0 to sub-channel #m+2) in the resource pool as an example.

In the example of FIG. 6, the coexistence of PSSCH transmissions from a slot UE and a sub-slot UE is shown.

Specifically, it is assumed that: a PSSCH transmission (e.g., PSSCH transmission #1) transmitted by a Tx UE (e.g., UE-1) to an Rx UE (e.g., UE-3) is a slot level PSSCH transmission, and the PSSCH transmission #1 is transmitted on resources of slot #n+1 and sub-channels #m+0 and #m+1.

In addition, it is assumed that: another PSSCH transmission (e.g., PSSCH transmission #2) transmitted by another Tx UE (e.g., UE-2) to another Rx UE (e.g., UE-4) is a sub-slot level PSSCH transmission, and the PSSCH transmission #2 is transmitted on resources of slot #n+5 and sub-channels #m+0 to #m+2. For example, the PSSCH transmission #2 is transmitted on resources of sub-slot #0 in slot #n+5.

Moreover, it is also assumed that the UE-3 and the UE-4 have obtained first configuration information including one set of parameters (Offset1=3 slots, Period1=4 slots, and MinGap1=3 slots) associated with slot level PSSCH transmission and another set of parameters (Offset2=1 slot, Period2=2 slots, and MinGap2=1 slot) associated with sub-slot level PSSCH transmission. It is also assumed that the UE-3 and the UE-4 have obtained second configuration information indicating PSFCH resources in the frequency domain as described above with respect to FIG. 3.

In some embodiments of the subject application, the UE-3 may transmit HARQ feedback (i.e., a first intended PSFCH transmission) for the PSSCH transmission #1 from the UE-1. Thus, the UE-3 may determine at least one resource for the HARQ feedback.

Specifically, based on Offset1 and Period1, the UE-3 may determine that the PSFCH symbols for slot level PSSCH transmissions may be on slot #n+3 and slot #n+7. According to MinGap1, the UE-3 may determine that the HARQ feedback (i.e., the first intended PSFCH transmission) for the PSSCH transmission #1 may be transmitted on a PSFCH symbol in slot #n+7. Actually, the PSFCH symbol may be used to transmit HARQ feedback for all the slot level PSSCH transmissions on slot #n+1 to slot #n+4.

Then, the UE-3 may determine whether the PSFCH symbol is an SFS or an IFS based on a time offset and a period associated with each PSSCH transmission type as indicated by the first configuration information. For example, based on condition (1) as stated above, the UE-3 may determine that the PSFCH symbol is an SFS. Then, the UE-3 may determine a first PRB list from all the PRB feedback lists included in the second configuration information based on the PSFCH symbol type and/or PSSCH transmission type of PSSCH transmission #1. For example, the first PRB list for the HARQ feedback may be PRB-FB-List #A1 as shown in Table 1.

After determining the first PRB list (e.g., PRB-FB-List #A1), the UE-3 may determine a second PRB list from the PRB-FB-List #A1 based on a slot index of PSSCH transmission #1, sub-channel index(es) of PSSCH transmission #1, and a resource mapping type included in the second configuration information. Then, the UE-3 may determine the at least one PSFCH resource for the first intended PSFCH transmission based on at least one of: the second PRB list; at least one code for the first intended PSFCH transmission; an identity of the UE-3; or an identity of the UE-1.

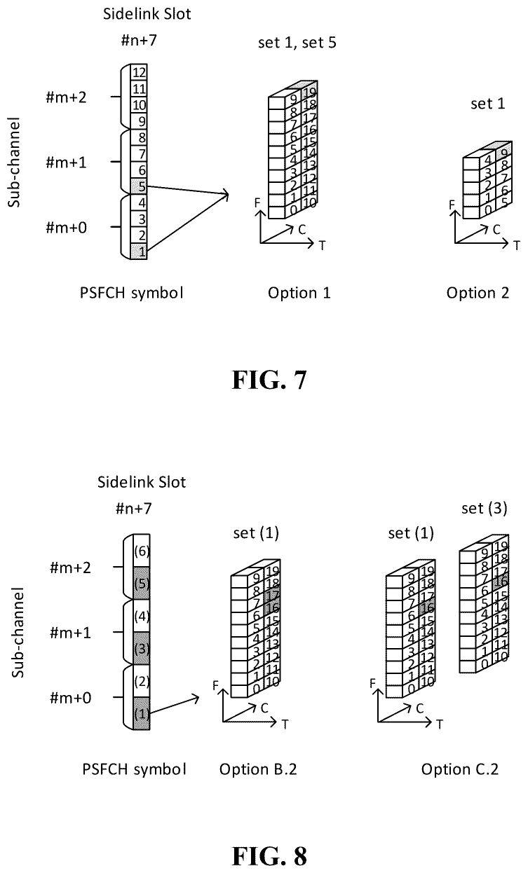

The specific examples may refer to Table 2 and FIG. 7 which are described below.

For example, the following Table 2 illustrates two example options (e.g., Option 1 and Option 2) for determining the second PRB list and a number of PRBs for transmitting the first intended PSFCH transmission.

TABLE 1

| Option index | N_{PRB}^{S-FB} | Resource mapping type |
|---|---|---|
| Option 1 | =1 | The PRB is within PSFCH resources |
| | | corresponding to all sub-channels of the |
| | | associated PSSCH transmission. |
| Option 2 | =1 | The PRB is within PSFCH resources |
| | | corresponding to only one sub-channel |
| | | (such as the starting sub-channel) of the |
| | | associated PSSCH transmission |

Note:
N_{PRB}^{S-FB} indicates the number of PRBs for each HARQ feedback to an associated PSSCH transmission for a slot UE.

According to Table 2, each option may be a combination of two parameters, e.g., a number of PRBs for PSFCH transmission and a resource mapping type for PSFCH transmission. The UE-3 may determine either Option 1 or Option 2 based on at least one of the second configuration information or the SCI transmitted by the UE-1. For example, in Table 2, the number of PRBs for slot level PSSCH transmission is 1, which may be configured or pre-configured in the second configuration information or may be a default value. In an example, the resource mapping type may be the one included in the second configuration information in the case that the second configuration information includes only one resource mapping type. In another example, the SCI associated with PSSCH transmission #1 may indicate one resource mapping type for the first intended PSFCH transmission from multiple resource mapping types included in the second configuration information.

FIG. 7 illustrates an exemplary method for determining PSFCH resources in the frequency domain according to some embodiments of the present application. The PSFCH resources are used for transmitting the first intended PSFCH transmission for PSSCH transmission #1 as shown in FIG. 6.

In the example of FIG. 7, it is assumed that the first PRB list determined (as described above) by the UE-3 includes 20 PRBs for each channel, then the PSFCH symbol in FIG. 6 may include 60 PRBs in total in sub-channels #m+0, #m+1, and #m+2. These 60 PRBs may be used for PSFCH transmissions associated with all the slot level PSSCH transmissions on slot #n+1 to slot #n+4.

As shown in FIG. 6, the resources for all the slot level PSSCH transmissions on slot #n+1 to slot #n+4 may be divided into 12 PSSCH resource sets (labeled from 1 to 12, respectively), wherein each PSSCH resource set may include resources in one sub-channel and one slot. Then, referring to FIG. 7, the 20 PRBs in each sub-channel of the PSFCH symbol are divided into 4 PRB sets, where each PRB set is associated with PSSCH slots (e.g., 4 slots) within the same sub-channel. Thus, the 60 PRBs in the PSFCH symbol are divided into 12 PRB sets (labeled from 1 to 12, respectively), where each PRB set may include 5 PRBs. The 12 PSSCH resource sets are associated with the 12 PRB sets by one-to-one mapping. For example, if a PSSCH transmission is transmitted on a PSSCH resource set with index of iϵ[1 . . . 12], the corresponding PRB set is also with an index of i. In the example of FIG. 7, since the PSSCH transmission #1 is transmitted on PSSCH resource set 1 and PSSCH resource set 5, the corresponding PRB sets are PRB set 1 and PRB set 5.

In the case that the UE-3 determines Option 1 in Table 2 for the first intended PSFCH transmission, both PRB set 1 and PRB set 5 in the PSFCH symbol are determined as the second PRB list which can be used for HARQ feedback to the UE-1. It is assumed that there are Q=2 cyclic shift pairs used for HARQ feedback, where each pair of cyclic shifts (within a PRB) are used to distinguish the ACK or NACK from the UE-3. PRB sets 1 and 5 which include 10 PRBs in total may include K=20 resources in the frequency domain and the code domain, which are labeled from resource 0 to resource 19. The resource with index i in the K resources which is used for transmitting the first intended PSFCH transmission (e.g., HARQ feedback) may be calculated by the following equation (3):

$$i = ( {T}_{ID} + {R}_{ID} ) mod ( K ) \qquad ( 3 )$$

T_{ID} is an ID (e.g., layer 1 ID) of the UE-1 associated with PSSCH transmission #1. R_{ID} is set as an ID of the UE-3 in case of groupcast option 2 (e.g., ACK/NACK feedback). R_{ID} is set as 0 in case of unicast or groupcast option 1 (e.g., NACK-only feedback). For example, if T_{ID}+R_{ID} is 79, the value of i is calculated as 19. In that case, the resource used for HARQ feedback is resource 19.

In the case that the UE-3 determines Option 2 in Table 2 for the first intended PSFCH transmission, only PRB set 1 corresponding to the starting sub-channel of the PSSCH transmission #1 is determined as the second PRB list which can be used for HARQ feedback to the UE-1. PRB set 1 which includes 5 PRBs in total may include K=10 resources in the frequency domain and the code domain, which are labeled from resources 0 to 9. In this example, if equation (3) is also applied and T_{ID}+R_{ID} is 79, then the value of i is calculated as 9. In that case, the resource used for HARQ feedback is resource 9.

In some other embodiments of the subject application, the UE-4 may transmit HARQ feedback (i.e., a second intended PSFCH transmission) for the PSSCH transmission #2 from the UE-2. Thus, the UE-4 may determine at least one resource for the HARQ feedback.

Specifically, based on Offset2 and Period2, the UE-4 may determine that the PSFCH symbols for sub-slot level PSSCH transmission may be in slot #n+1, slot #n+3, #n+5, and slot #n+7. According to the MinGap2, the UE-4 may determine that the HARQ feedback (i.e., the second intended PSFCH transmission) for the PSSCH transmission #2 may be transmitted on the PSFCH symbol in slot #n+7. Actually, the PSFCH symbol may be used to transmit HARQ feedback for all the sub-slot level PSSCH transmissions on slot #n+5 and slot #n+6.

Then, the UE-4 may determine whether the PSFCH symbol is an SFS or an IFS based on a time offset and a period associated with each PSSCH transmission type as indicated by the first configuration information. For example, based on condition (1) as stated above, the UE-4 may determine that the PSFCH symbol is an SFS. Then, the UE-4 may determine a first PRB list from all the PRB feedback lists included in the second configuration information based on the PSFCH symbol type and/or PSSCH transmission type of PSSCH transmission #2. For example, the first PRB list for the HARQ feedback may be PRB-FB-List #A2 as shown in Table 1.

After determining the first PRB list (e.g., PRB-FB-List #A2), the UE-4 may determine a second PRB list from the PRB-FB-List #A2 based on a slot index of PSSCH transmission #2, sub-channel index(es) of PSSCH transmission #2, and a resource mapping type included in the second configuration information. Then, the UE-4 may determine the at least one PSFCH resource for the second intended PSFCH transmission based on at least one of: the second PRB list; at least one code for the second intended PSFCH transmission; an identity of the UE-4; an identity of the UE-2; a sub-slot level index (e.g. “0” in the example of FIG. 6) of PSSCH transmission #2; a number of PRBs for the second intended PSFCH transmission; or a resource pattern for the second intended PSFCH transmission.

The specific examples may refer to Table 3 and FIG. 8 which are described below.

For example, the following Table 3 illustrates six options (e.g., Option A.1, Option A.2, Option B.1, Option B.2, Option C.1, and Option C.2) for determining the second PRB list and a number of PRB for transmitting the second intended PSFCH transmission.

TABLE 3

| Option | | Resource | |
|---|---|---|---|
| index | N_{PRB}^{SS-FB} | pattern | Resource mapping type |
| Option | =1 | — | the PRB is within PSFCH resources corresponding to |
| A.1 | | | all sub-channels of the associated PSSCH transmission. |
| Option | =1 | — | the PRB is within PSFCH resources corresponding to |
| A.2 | | | only one sub-channel (such as the starting sub-channel) |
| | | | of the associated PSSCH transmission |
| Option | >1 | contiguous | the PRBs are within PSFCH resources corresponding to |
| B.1 | | | all sub-channels of the associated PSSCH transmission |
| Option | >1 | contiguous | the PRBs are within PSFCH resources corresponding to |
| B.2 | | | one sub-channel (such as the starting sub-channel) of the |
| | | | associated PSSCH transmission |
| Option | >1 | interleaved | if N_{PRB}^{SS-FB} <= N_{SCh}, the PRBs are within PSFCH |
| C.1 | | | resources corresponding to N_{PRB}^{SS-FB} sub-channels |
| | | | (such as the first N_{PRB}^{SS-FB} sub-channels from the starting |
| | | | sub-channel); otherwise, fall back to option B.1 |
| Option | >1 | interleaved | if N_{PRB}^{SS-FB} <= N_{SCh}, the PRBs are within PSFCH |
| C.2 | | | resources corresponding to N_{PRB}^{SS-FB} sub-channels |
| | | | (such as the first N_{PRB}^{SS-FB} sub-channels from the starting |
| | | | sub-channel); otherwise, fall back to option B.2 |

Note:
N_{PRB}^{SS-FB} indicates the number of PRBs for each HARQ feedback to an associated PSSCH transmission for a sub-slot UE.
N_{SCh} indicates the number of sub-channels for the associated PSSCH transmission.

According to Table 3, each option may be a combination of three parameters, e.g., a number of PRBs for PSFCH transmission, a resource pattern for PSFCH transmission, and a resource mapping type for PSFCH transmission. The UE-4 may determine one option from the above six options based on at least one of the second configuration information or the SCI transmitted by the UE-2. For example, if at least one parameter in Table 3 can be uniquely determined based on the second configuration information, the UE-4 may determine the at least one parameter based on the second configuration information; otherwise, for any parameter that cannot be determined based on the second configuration information, the SCI associated with PSSCH transmission #2 transmitted by the UE-2 may indicate the parameter for the second intended PSFCH transmission.

FIG. 8 illustrates another exemplary method for determining PSFCH resources in the frequency domain according to some embodiments of the present application. The PSFCH resources are used for transmitting the second intended PSFCH transmission for PSSCH transmission #2 as shown in FIG. 6.

In the example of FIG. 8, it is assumed that the first PRB list determined (as described above) by the UE-4 includes 20 PRBs for each channel, then the PSFCH symbol in FIG. 6 may include 60 PRBs in sub-channels #m+0, #m+1, and #m+2. These 60 PRBs may be used for PSFCH transmissions associated with all the sub-slot level PSSCH transmissions on slot #n+5 and slot #n+6.

As shown in FIG. 6, the resources for all the sub-slot level PSSCH transmissions on slot #n+5 and slot #n+6 may be divided into 6 PSSCH resource sets (labeled from (1) to (6), respectively), wherein each PSSCH resource set may include resources in one sub-channel and one slot. Then, referring to FIG. 8, the 20 PRBs in each sub-channel of the PSFCH symbol are divided into 2 PRB sets, where each PRB set is associated with PSSCH slots (e.g. 2 slots) within the same sub-channel. Thus, the 60 PRBs in the PSFCH symbol are divided into 6 PRB sets (labeled from (1) to (6), respectively), where each PRB set may include 10 PRBs. The 6 PSSCH resource sets are associated with the 6 PRB sets by one-to-one mapping. For example, if a PSSCH transmission is transmitted on a PSSCH resource set with index of iϵ[1 . . . 6], the corresponding PRB set is also with an index of i. In the example of FIG. 8, since the PSSCH transmission #2 is transmitted on PSSCH resource sets (1), (3), and (5), the corresponding PRB sets are PRB sets (1), (3), and (5).

In the case that the UE-4 determines Option B.2 in Table 3 for the second intended PSFCH transmission, only PRB set (1) corresponding to the starting sub-channel of the PSSCH transmission #2 is determined as the second PRB list which can be used for HARQ feedback to the UE-2. It is assumed that there are Q=2 cyclic shift pairs used for HARQ feedback, where each pair of cyclic shifts (within a PRB) are used to distinguish the ACK or NACK from the UE-4. PRB set (1) which includes 10 PRBs in total may include K=20 resources in the frequency domain and the code domain, which are labeled from resource 0 to resource 19.

Then, the resources for HARQ feedback may have indexes from i to i+N_{PRB}^{SS-FB}−1 (e.g., N_{PRB}^{SS-FB}=2 in the example of FIG. 8). The index i can be calculated by the following equation (4):

$$i = ( {T}_{ID} + {R}_{ID} + a * {I}_{SS} + b ) mod ( K ) \qquad ( 4 )$$

T_{ID} is an ID (e.g., layer 1 ID) of the UE-2 associated with PSSCH transmission #2. R_{ID} is set as an ID of the UE-4 in case of groupcast option 2 (e.g., ACK/NACK feedback). R_{ID} is set as 0 in case of unicast or groupcast option 1 (e.g., NACK-only feedback). I_{SS} is a sub-slot index of PSSCH transmission #2 within the slot for PSSCH transmission #2 from the UE-2, and thus I_{SS}=0 in this example. The parameters of a and b are set aiming at collision avoidance. For example, the setting of a=b=N_{PRB}^{SS-FB}=2 is to avoid resource collision for PSFCH resources associated with PSSCH transmissions (e.g., a PSSCH transmission in sub-slot #1 in slot #n+5 in FIG. 6) in adjacent sub-slots within the same slot. For example, if i is calculated as 16, resource 16 and resource 17 are determined to be used for the second intended PSFCH transmission.

In the case that the UE-4 determines Option A.2 in Table 3 for the second intended PSFCH transmission, the PSFCH resource selection may be similar to Option B.2. The difference is that only one resource with index i is used for transmitting the second intended PSFCH transmission.

In the case that the UE-4 determines Option B.1 in Table 3 for the second intended PSFCH transmission, the PSFCH resource selection may be similar to Option B.2. The difference is that the PRB sets (1), (3), and (5) are all determined as the second PRB list which can be used for the second intended PSFCH transmission, and thus the second PRB list includes K=60 resources in the frequency domain and the code domain. Then, the UE-4 may use K=60 in equation (4) to determine the index i of the resource for the second intended PSFCH transmission.

In the case that the UE-4 determines Option A.1 in Table 3 for the second intended PSFCH transmission, the PSFCH resource selection may be similar to Option B.1. The difference is that only one resource with index i is used for transmitting the second intended PSFCH transmission.

In the case that the UE-4 determines Option C.2 in Table 3 for the second intended PSFCH transmission, since in the example of FIG. 8, N_{PRB}^{SS-FB} (i.e., 2)<=N_{SCh} (i.e., 3), PRB sets (1) and (3) corresponding to the first 2 starting sub-channels of the PSSCH transmission #2 are determined as the second PRB list which can be used for HARQ feedback to the UE-2. The interleaved pattern represents that the resources for HARQ feedback having the same index i in every available PRB set.

Then, a value of index i can also be calculated by equation (4), wherein the values of a and b may be set as 1, and K=20 resources in the frequency domain and code domain for each of PRB sets (1) and (3). In such example, if i is calculated as 16, resource 16 in PRB set (1) and resource 16 in PRB set (3) are determined to be used for HARQ feedback.

In the case that the UE-4 determines Option C.1 in Table 3 for the second intended PSFCH transmission, in the example of FIG. 8, since N_{PRB}^{SS-FB} (i.e., 2)<=N_{SCh} (i.e., 3), the PSFCH resource selection may be the same as Option C.2.

The resources shown in FIG. 7 and FIG. 8 are contiguous in the logical domain, rather than in the physical domain. For example, in the case that Option B.1 is applied, the resources in PRB sets (1), (3) and (5) may be labelled in consecutive way in the logical domain. Actually, if the PRBs determined to be used for HARQ feedback are located in different PRB sets, they are not contiguous in the frequency domain.

In the examples of FIGS. 6-8, the second PRB list may be determined by an Rx UE (e.g., UE-3 or UE-4). However, as stated above, the second PRB list (e.g., a range of available PRBs) from the first PRB list associated with each PSSCH transmission may be determined by a Tx UE associated with the PSSCH transmission based on sensing results during resource selection, and indicated to the Rx UE in the SCI associated with the PSSCH transmission. In some embodiments, the second PRB list may be represented in terms of index(es) of PRB set(s). Taking Option C.2 in FIG. 8 as an example, the second PRB list indicated by the Tx UE may be sets (1) and (3), sets (1) and (5), or sets (3) and (5). In the cases that the second PRB list is indicated by the Tx UE, the other steps for determining the resource(s) for an intended PSFCH transmission may be the same as the examples described with respect to FIGS. 6-8.

The above embodiments may solve the technical problem of resource collision among PSFCH transmissions from multiple UEs, including sub-slot level UEs and/or slot level UEs.

The following embodiments may solve the technical problem of resource collision among multiple PSFCH transmissions and/or PSFCH receptions for one sub-slot level UE.

In some embodiments of the present application, a UE (e.g., a sub-slot UE) may need to transmit multiple PSFCH transmissions simultaneously. Then, the UE may determine to transmit up to a configured or pre-configured number of PSFCH transmission(s) based on priority (ies) (which is indicated in the 1st-stage SCI) of the associated PSSCH transmission(s). For a PSFCH transmission which is determined to be transmitted by the UE, the UE may use any method described in the above embodiments to determine the at least one resource for the PSFCH transmission.

In some other embodiments of the present application, a UE (e.g., a sub-slot UE) may need to receive a PSFCH transmission and transmit a PSFCH transmission simultaneously. Then, the UE may determine to transmit or receive PSFCH transmission based on priorities (e.g., indicated in the 1st-stage SCI) of the associated PSSCH transmissions.

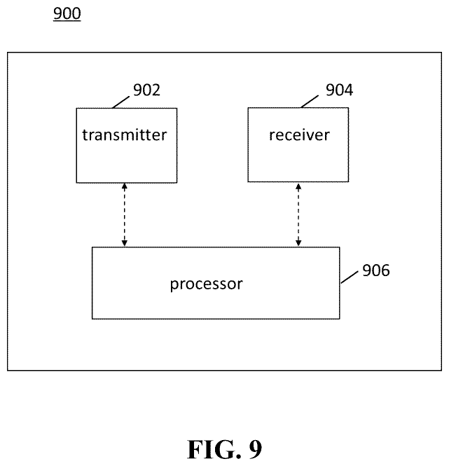

FIG. 9 illustrates a simplified block diagram of an exemplary apparatus 900 for PSFCH transmission according to some embodiments of the present application. In some embodiments, the apparatus 900 may be or include at least part of a UE (e.g., UE 101a or UE 101b in FIG. 1). In some other embodiments, the apparatus 900 may be or include at least part of a BS (e.g., BS 102 in FIG. 1).

Referring to FIG. 9, the apparatus 900 may include at least one transmitter 902, at least one receiver 904, and at least one processor 906. The at least one transmitter 902 is coupled to the at least one processor 906, and the at least one receiver 904 is coupled to the at least one processor 906.

Although in this figure, elements such as the transmitter 902, the receiver 904, and the processor 906 are illustrated in the singular, the plural is contemplated unless a limitation to the singular is explicitly stated. In some embodiments of the present application, the transmitter 902 and the receiver 904 may be combined to one device, such as a transceiver. In some embodiments of the present application, the apparatus 900 may further include an input device, a memory, and/or other components. The transmitter 902, the receiver 904, and the processor 906 may be configured to perform any of the methods described herein (e.g., the methods described with respect to FIG. 3-8).

According to some embodiments of the present application, the apparatus 900 may be an Rx UE, and the transmitter 902, the receiver 904, and the processor 906 may be configured to perform operations of any method as described with respect to FIGS. 3-8. For example, the processor 906 may be configured to: obtain first configuration information indicating PSFCH resources in the time domain, wherein the first configuration information includes at least one set of parameters associated with at least one PSSCH transmission type, wherein each set of parameters includes at least one of: a time offset, a period, or a minimum gap; obtain second configuration information indicating PSFCH resources in the frequency domain, wherein the second configuration information includes at least one of: PRB feedback list(s) available for PSFCH transmission(s); number(s) of PRBs for PSFCH transmission(s); resource pattern(s) for PSFCH transmission(s); or resource mapping type(s) for PSFCH transmission(s); and determine at least one PSFCH resource for an intended PSFCH transmission based on the first configuration information, the second configuration information, and a PSSCH transmission associated with the intended PSFCH transmission. The transmitter 902 may be configured to transmit the intended PSFCH transmission on the determined at least one PSFCH resource.

According to some embodiments of the present application, the apparatus 900 may be a BS. The transmitter 902 may be configured to transmit first configuration information indicating PSFCH resources in the time domain, wherein the first configuration information includes at least one set of parameters associated with at least one PSSCH transmission type, wherein each set of parameters includes at least one of: a time offset, a period, or a minimum gap; and transmit second configuration information indicating PSFCH resources in the frequency domain, wherein the second configuration information includes at least one of: PRB feedback list(s) available for PSFCH transmission(s); number(s) of PRBs for PSFCH transmission(s); resource pattern(s) for PSFCH transmission(s); or resource mapping type(s) for PSFCH transmission(s).

In some embodiments of the present application, the apparatus 900 may further include at least one non-transitory computer-readable medium. In some embodiments of the present disclosure, the non-transitory computer-readable medium may have stored thereon computer-executable instructions to cause the processor 906 to implement any of the methods as described above. For example, the computer-executable instructions, when executed, may cause the processor 906 to interact with the transmitter 902 and/or the receiver 904, so as to perform operations of the methods, e.g., as described with respect to FIGS. 3-8.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for PSFCH transmission, including a processor and a memory. Computer programmable instructions for implementing a method for PSFCH transmission are stored in the memory, and the processor is configured to perform the computer programmable instructions to implement the method for PSFCH transmission. The method for PSFCH transmission may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for PSFCH transmission according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
obtain first configuration information indicating physical sidelink feedback channel (PSFCH) resources in a time domain, wherein the first configuration information includes at least one set of parameters associated with at least one physical sidelink shared channel (PSSCH) transmission type, wherein each set of parameters includes at least one of:
a time offset,
a period, or
a minimum gap;
obtain second configuration information indicating PSFCH resources in a frequency domain, wherein the second configuration information includes at least one of:
physical resource block (PRB) feedback lists available for PSFCH transmissions;
numbers of PRBs for PSFCH transmissions;
resource patterns for PSFCH transmissions; or
resource mapping types for PSFCH transmissions; and
determine at least one PSFCH resource for an intended PSFCH transmission based on the first configuration information, the second configuration information, and a PSSCH transmission associated with the intended PSFCH transmission; and
transmit the intended PSFCH transmission on the determined at least one PSFCH resource.

2. The UE of claim 1, wherein the at least one set of parameters is configured or pre-configured in at least one of the following granularities:
per resource pool; or
per PSSCH transmission type.

3. The UE of claim 1, wherein a PSSCH transmission type indicates that a PSSCH transmission belongs to a slot level or a sub-slot level.

4. The UE of claim 1, wherein the resource patterns include at least one of a contiguous pattern or an interleaved pattern, wherein the contiguous pattern indicates that PRBs for a PSFCH transmission are labeled in a consecutive way within a range of resources for the PSFCH transmission, and wherein the interleaved pattern indicates that PRBs for a PSFCH transmission have a same index in multiple PRB sets within a range of resources for the PSFCH transmission.

5. The UE of claim 1, wherein at least one of the numbers of PRBs or the resource patterns are configured or pre-configured in at least one of the following granularities:
per resource pool,
per PSSCH transmission type,
per PSFCH symbol type, or
per priority of an associated PSSCH transmission.

6. The UE of claim 5, wherein the PSFCH symbol type includes a shared PSFCH symbol (SFS) or an independent PSFCH symbol (IFS).

7. The UE of claim 1, wherein, to determine the at least one PSFCH resource for the intended PSFCH transmission, the at least one processor is configured to cause the UE to:
determine a set of parameters from the at least one set of parameters based on a PSSCH transmission type of the PSSCH transmission; and
determine a slot index of a slot for the PSFCH transmission based on a slot index of the PSSCH transmission and the set of parameters.

8. The UE of claim 7, wherein the at least one processor is further configured to cause the UE to:
determine a PSFCH symbol type of a PSFCH symbol in the slot for the PSFCH transmission based on a time offset and a period associated with each PSSCH transmission type as indicated by the first configuration information.

9. The UE of claim 1, wherein the PRB feedback lists includes a PRB feedback list for shared PSFCH symbol (SFS) for slot level PSSCH transmission, a PRB feedback list for SFS for sub-slot level PSSCH transmission, a PRB feedback list for independent PSFCH symbol (IFS) for slot level PSSCH transmission, and a PRB feedback list for IFS for sub-slot level PSSCH transmission.

10. The UE of claim 9, wherein, to determine the at least one PSFCH resource for the intended PSFCH transmission, the at least one processor is configured to cause the UE to:
determine a first PRB list for the intended PSFCH transmission from the PRB feedback list for SFS for slot level PSSCH transmission, the PRB feedback list for SFS for sub-slot level PSSCH transmission, the PRB feedback list for IFS for slot level PSSCH transmission, and the PRB feedback list for IFS for sub-slot level PSSCH transmission based on at least one of:
whether a PSFCH symbol for the intended PSFCH transmission is an SFS or an IFS; or
whether the PSSCH transmission is a slot level PSSCH transmission or a sub-slot level PSSCH transmission.

11. The UE of claim 10, wherein, to determine the at least one PSFCH resource for the intended PSFCH transmission, at least one processor is configured to cause the UE to:
determine a second PRB list from the first PRB list based on a slot index of the PSSCH transmission, sub-channel indexes of the PSSCH transmission, and a resource mapping type included in the second configuration information, wherein the resource mapping type indicates whether the second PRB list is within PSFCH resources corresponding to all sub-channels of the PSSCH transmission or a part of sub-channels of the PSSCH transmission; or
receive sidelink control information (SCI) associated with the PSSCH transmission, wherein the SCI indicates a second PRB list from the first PRB list for the intended PSFCH transmission.

12. The UE of claim 11, wherein, when the PSSCH transmission is a slot level PSSCH transmission, the at least one processor is configured to cause the UE to determine the at least one PSFCH resource for the intended PSFCH transmission based on at least one of:
the second PRB list;
at least one code for the intended PSFCH transmission;
an identity of the UE; or
an identity of a transmitting UE associated with the PSSCH transmission.

13. The UE of claim 11, wherein, when the PSSCH transmission is a sub-slot level PSSCH transmission, the at least one processor is configured to cause the UE to determine the at least one PSFCH resource for the intended PSFCH transmission based on at least one of:
the second PRB list;
at least one code for the intended PSFCH transmission;
an identity of the UE;
an identity of a transmitting UE associated with the PSSCH transmission;
a sub-slot level index of the PSSCH transmission;
a number of PRBs for the intended PSFCH transmission; or
a resource pattern for the intended PSFCH transmission.

14. A base station (BS) for wireless communication, comprising:
at least one memory; and
at least one processor coupled with the at least one memory and configured to cause the BS to:
transmit first configuration information indicating physical sidelink feedback channel (PSFCH) resources in a time domain, wherein the first configuration information includes at least one set of parameters associated with at least one physical sidelink shared channel (PSSCH) transmission type, wherein each set of parameters includes at least one of:
a time offset,
a period, or
a minimum gap; and
transmit second configuration information indicating PSFCH resources in a frequency domain, wherein the second configuration information includes at least one of:
physical resource block (PRB) feedback lists available for PSFCH transmissions;
numbers of PRBs for PSFCH transmissions;
resource patterns for PSFCH transmissions; or
resource mapping types for PSFCH transmissions.

15. A method performed by a user equipment (UE), the method comprising:
obtaining first configuration information indicating physical sidelink feedback channel (PSFCH) resources in a time domain, wherein the first configuration information includes at least one set of parameters associated with at least one physical sidelink shared channel (PSSCH) transmission type, wherein each set of parameters includes at least one of:
a time offset,
a period, or
a minimum gap;
obtaining second configuration information indicating PSFCH resources in a frequency domain, wherein the second configuration information includes at least one of:
physical resource block (PRB) feedback lists available for PSFCH transmissions;
numbers of PRBs for PSFCH transmissions;
resource patterns for PSFCH transmissions; or
resource mapping types for PSFCH transmissions;
determining at least one PSFCH resource for an intended PSFCH transmission based on the first configuration information, the second configuration information, and a PSSCH transmission associated with the intended PSFCH transmission; and
transmitting the intended PSFCH transmission on the determined at least one PSFCH resource.

16. A processor for wireless communication, comprising:
at least one controller coupled with at least one memory and configured to cause the processor to:
obtain first configuration information indicating physical sidelink feedback channel (PSFCH) resources in a time domain, wherein the first configuration information includes at least one set of parameters associated with at least one physical sidelink shared channel (PSSCH) transmission type, wherein each set of parameters includes at least one of:
a time offset,
a period, or
a minimum gap;
obtain second configuration information indicating PSFCH resources in a frequency domain, wherein the second configuration information includes at least one of:
physical resource block (PRB) feedback lists available for PSFCH transmissions;
numbers of PRBs for PSFCH transmissions;
resource patterns for PSFCH transmissions; or
resource mapping types for PSFCH transmissions;
determine at least one PSFCH resource for an intended PSFCH transmission based on the first configuration information, the second configuration information, and a PSSCH transmission associated with the intended PSFCH transmission; and
transmit the intended PSFCH transmission on the determined at least one PSFCH resource.

17. The processor of claim 16, wherein the at least one set of parameters is configured or pre-configured in at least one of the following granularities:
per resource pool; or
per PSSCH transmission type.

18. The processor of claim 16, wherein a PSSCH transmission type indicates that a PSSCH transmission belongs to a slot level or a sub-slot level.

19. The UE processor of claim 16, wherein the resource patterns include at least one of a contiguous pattern or an interleaved pattern, wherein the contiguous pattern indicates that PRBs for a PSFCH transmission are labeled in a consecutive way within a range of resources for the PSFCH transmission, and wherein the interleaved pattern indicates that PRBs for a PSFCH transmission have a same index in multiple PRB sets within a range of resources for the PSFCH transmission.

20. The processor of claim 16, wherein at least one of the numbers of PRBs or the resource patterns are configured or pre-configured in at least one of the following granularities:
per resource pool,
per PSSCH transmission type,
per PSFCH symbol type, or
per priority of an associated PSSCH transmission.
